(19) United States
(12) Patent Application Publication
(10) Pub. No.: US 2021/0304339 A1
(43) Pub. Date: Sep. 30, 2021

(54) SYSTEM AND A METHOD FOR LOCALLY ASSESSING A USER DURING A TEST SESSION

(71) Applicant: Socratease Edtech India Private Limited, Bangalore (IN)

(72) Inventor: Jayanth Tallakere Neelakanta, Bangalore (IN)

(73) Assignee: Socratease Edtech India Private Limited

(21) Appl. No.: 17/213,298

(22) Filed: Mar. 26, 2021

(30) Foreign Application Priority Data
Mar. 27, 2020 (IN) 202041013481

(51) Int. Cl. G06Q 50/20; G09B 7/00; G06N 20/00

(52) U.S. Cl. CPC G06Q 50/205; G06N 20/00; G09B 7/00

(57) ABSTRACT

A system and method for locally assessing a user during a test session on a user device is disclosed. The system and method include acquisition of one or more user data associated with a user during a test session. The test session is hosted locally on the user device. One or more user assessment parameters are extracted from the acquired one or more user data locally on the user device. It is determined locally on the user device, whether the extracted one or more user assessment parameters violates the set of predefined test assessment criteria based on a machine learning based user assessment model. This determination happens on the device directly, without it having to be processed by a server. A trust score is generated based on the violations the user commits during the test. Further, a notification message is generated indicating violation of test by the user. The trust score and the generated notification message are displayed on a user interface of the user device.

This application claims priority from a provisional patent application filed in India having Patent Application No. 202041013481, filed on Mar. 27, 2020, and titled “CLIENT-SIDE AUTO PROCTOR SYSTEM FOR COMPUTERISED TEST ASSESSMENT AND METHOD THEREOF”.

### FIELD OF INVENTION

Embodiments of the present disclosure relate to a proctoring system for a test session, and more particularly to a system and a method for locally assessing a user during a test session.

### BACKGROUND

Traditionally, students or interested people qualify certain tests or examinations in order to prove that they have gained knowledge, or they are eligible to undertake certain activities. With many tests and assessments having moved online, it is no longer required for people to attend the test or examination physically at any examination hall or any predefined premises. Online tests have significantly reduced the cost of operations since no vast examination halls need to be booked, no question paper and answer sheets need to be printed, no security arrangements need to be made, examinees are not required to travel, and the like. In spite of the aforementioned advantages, the biggest challenge in an online test is the prevention of malpractice by the examinees or test takers.

Currently, to ensure fairness of online or computerised tests or exams, several proctors or supervisors are appointed to remotely monitor audio and video feeds of examinees. The remote monitoring of the exam being conducted not only requires sufficient manpower of the proctors or the supervisors, but also requires high data and bandwidth of network for the remote processing of user data. The remote processing of data increases the overhead cost and slows down the processing speed. Therefore, there is a need for a technique which efficiently prevents test takers from cheating or resorting to manipulation of the online or computerised tests or exams.

Hence, there is a need for an improved system for monitoring computerised tests taken by the users in remote locations or on online platforms, in order to address the aforementioned issues.

### SUMMARY

This summary is provided to introduce a selection of concepts, in a simple manner, which is further described in the detailed description of the disclosure. This summary is neither intended to identify key or essential inventive concepts of the subject matter nor to determine the scope of the disclosure.

In accordance with an embodiment of the present disclosure, a system is disclosed for locally assessing a user during a test session on a user device. The system includes one or more hardware processors on a user device and a memory on the user device coupled to the one or more hardware processors. The memory includes a plurality of modules in the form of programmable instructions executable by the one or more hardware processors. The plurality of modules includes a data acquisition module, a data extraction module, a data assessment module, a score generator module, a notification generator module, and a display module.

The data acquisition module is configured to acquire one or more user data associated with a user during a test session from one or more local input sources. The test session is hosted locally on the user device. The data extraction module is configured to extract one or more user assessment parameters from the acquired one or more user data locally on the user device. The data assessment module is configured to determine locally on the user device whether the extracted one or more user assessment parameters violates the set of predefined test assessment criteria based on a machine learning based user assessment model. The user assessment model represents a dynamic relationship between the extracted one or more user assessment parameters and a set of predefined test assessment criteria.

The score generator module is configured to generate a trust score for the user based on whether the extracted one or more user assessment parameters is determined to violate the set of predefined test assessment criteria. The notification generator module is configured to generate a notification message indicating violation of the test conditions by the user based on the generated trust score. The display module is configured to output the trust score and the generated notification message on a user interface of the user device.

To further clarify the advantages and features of the present disclosure, a more particular description of the disclosure will follow by reference to specific embodiments thereof, which are illustrated in the appended figures. It is to be appreciated that these figures depict only typical embodiments of the disclosure and are therefore not to be considered limiting in scope. The disclosure will be described and explained with additional specificity and detail with the appended figures.

### BRIEF DESCRIPTION OF DRAWINGS

The disclosure will be described and explained with additional specificity and detail with the accompanying figures in which:

FIG. 1 is a block diagram illustrating an exemplary system for locally assessing a user during a test session, in accordance with an embodiment of the present disclosure; and

FIG. 2 is a block diagram illustrating an exemplary method for locally assessing a user during a test session, in accordance with an embodiment of the present disclosure.

Further, those skilled in the art will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the embodiments of the present disclosure so as not to obscure the figures with details that will be readily apparent to those skilled in the art having the benefit of the description herein.

### DETAILED DESCRIPTION OF THE DISCLOSURE

For the purpose of promoting an understanding of the principles of the disclosure, reference will now be made to the embodiment illustrated in the figures and specific language will be used to describe them. It will nevertheless be understood that no limitation of the scope of the disclosure is thereby intended. Such alterations and further modifications in the illustrated system, and such further applications of the principles of the disclosure as would normally occur to those skilled in the art are to be construed as being within the scope of the present disclosure. It will be understood by those skilled in the art that the foregoing general description and the following detailed description are exemplary and explanatory of the disclosure and are not intended to be restrictive thereof.

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

The terms “comprise”, “comprising”, or any other variations thereof, are intended to cover a non-exclusive inclusion, such that one or more devices or sub-systems or elements or structures or components preceded by “comprises . . . a” does not, without more constraints, preclude the existence of other devices, sub-systems, additional sub-modules. Appearances of the phrase “in an embodiment”, “in another embodiment” and similar language throughout this specification may, but not necessarily do, all refer to the same embodiment.

Unless otherwise defined, all technical and scientific terms used herein have the same meaning as commonly understood by those skilled in the art to which this disclosure belongs. The system, methods, and examples provided herein are only illustrative and not intended to be limiting.

A computer system (standalone, client or server computer system) configured by an application may constitute a “module” that is configured and operated to perform certain operations. In one embodiment, the “module” may be implemented mechanically or electronically, so a module may comprise dedicated circuitry or logic that is permanently configured (within a special-purpose processor) to perform certain operations. In another embodiment, a “module” may also comprise programmable logic or circuitry (as encompassed within a general-purpose processor or other programmable processor) that is temporarily configured by software to perform certain operations.

Accordingly, the term “module” should be understood to encompass a tangible entity, be that an entity that is physically constructed, permanently configured (hardwired) or temporarily configured (programmed) to operate in a certain manner and/or to perform certain operations described herein.

Embodiments of the present disclosure disclose system for locally assessing a user during a test session on a user device. The system includes a memory on a local user device coupled to one or more hardware processors. The memory includes a plurality of modules in the form of programmable instructions executable by the one or more hardware processors. The plurality of modules includes a data acquisition module, a data extraction module, a data assessment module, a score generator module, a notification generator module, and a display module.

The data acquisition module is configured to acquire one or more user data associated with a user during a test session from one or more local input sources. The test session is hosted locally on the user device. The data extraction module is configured to extract one or more user assessment parameters from the acquired one or more user data locally on the user device. The data assessment module is configured to determine whether the extracted one or more user assessment parameters violates the set of predefined test assessment criteria based on a machine learning based user assessment model. The user assessment model represents a dynamic relationship between the extracted one or more user assessment parameters and a set of predefined test assessment criteria.

The score generator module is configured to generate a trust score for the user based on whether the extracted one or more user assessment parameters is determined to violate the set of predefined test assessment criteria. The notification generator module is configured to generate a notification message indicating violation of test by the user based on the generated trust score. The display module is configured to output the trust score and the generated notification message on a user interface of the user device.

In one embodiment the system is configured in the user's device locally to capture user's audio and video feeds from the user device including the continuous screen capture of display screen of the user device, receiving the captured audio and video feeds, monitoring a plurality of factors including number of users on the screen, direction of the eye gaze, audio cues, sudden changes to user environment, application in focus and the like. The user's device acts as a stand-alone device to perform the computerised test assessment of the users. Report generated after assessment is communicated to a remote server or to an administrator.

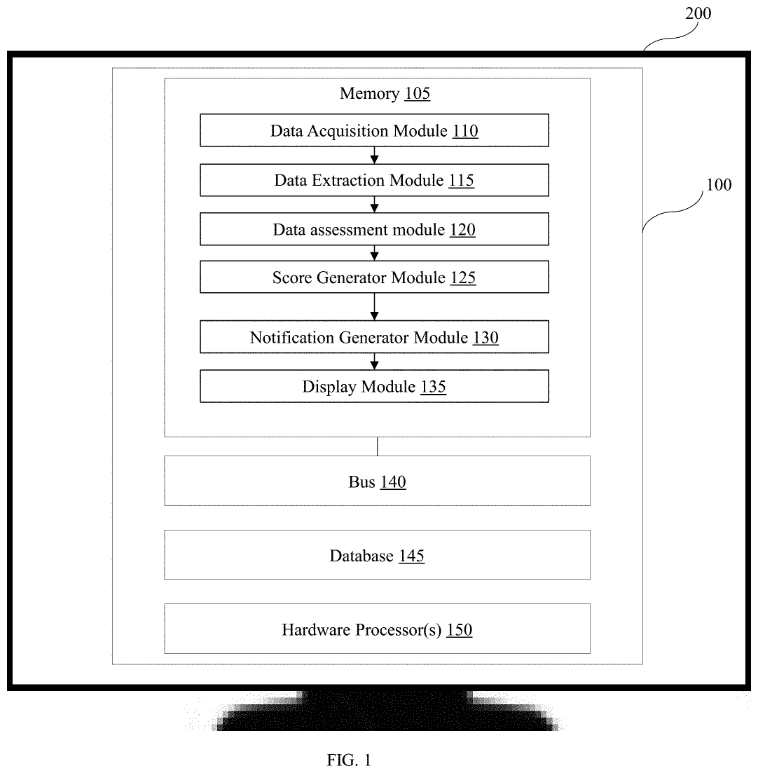

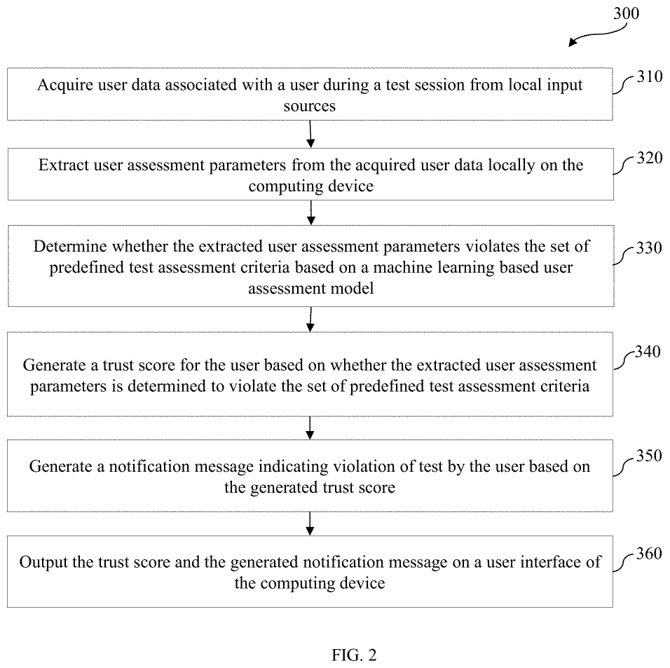

Referring now to the drawings, FIG. 1 and FIG. 2, illustrate preferred embodiments and these embodiments are described in the context of the following exemplary system and/or method.

FIG. 1 is a block diagram illustrating an exemplary system 100 for locally assessing a user during a test session on a user device 200, in accordance with an embodiment of the present disclosure. The system 100 is configured on the user device 200. The user device 200 is remotely connected to a testing server to access the test session in an online mode via a network connection. The test session is conducted on the user device 200 in the online mode via a web browser or other such client and the system 100 facilitates processing of one or more user data locally on the user device 200 to assess and prevent a user from using any wrongful means during the test session.

The network connection may be established via Wi-Fi, Hotspot, Broadband and the like. The user device 200 is any computing device including a laptop computer, desktop computer, tablet computer, smartphone and the like. The system 100 includes one or more hardware processor(s) 150, a bus 140, a database 145 and a memory 105 coupled to the one or more hardware processors 150. The hardware processor 150, and the memory 105, may be communicatively coupled by the bus 140, such as—a system bus or a similar mechanism.

The hardware processor(s) 150 (also referred herein as ‘processor’), as used herein, means any type of computational circuit, such as, but not limited to, a microprocessor unit, microcontroller, complex instruction set computing microprocessor unit, reduced instruction set computing microprocessor unit, very long instruction word microprocessor unit, explicitly parallel instruction computing microprocessor unit, graphics processing unit, digital signal processing unit, or any other type of processing circuit. The processor(s) 150 may also include embedded controllers, such as generic or programmable logic devices or arrays, application specific integrated circuits, single-chip computers, and the like.

The memory 105 may be non-transitory volatile memory and non-volatile memory. The memory 105 may be coupled for communication with the hardware processor(s) 150, such as being a computer-readable storage medium. The hardware processor(s) 150 may execute machine-readable instructions and/or source code stored in the memory 105. A variety of machine-readable instructions may be stored in and accessed from the memory 105. The memory 105 may include any suitable elements for storing data and machine-readable instructions, such as read only memory, random access memory, erasable programmable read only memory, electrically erasable programmable read only memory, a hard drive, a removable media drive for handling compact disks, digital video disks, diskettes, magnetic tape cartridges, memory cards, and the like. In the present embodiment, the memory 105 includes a plurality of subsystems stored in the form of machine-readable instructions on any of the above-mentioned storage media and may be in communication with and executed by the hardware processor(s) 150.

The memory 105 comprises a plurality of modules in the form of programmable instructions executable by the one or more hardware processors 150. The plurality of modules includes a data acquisition module 110, a data extraction module 115, a data assessment module 120, a score generator module 125, a notification generator module 130, and a display module 135.

The data acquisition module 110 is configured to acquire one or more user data associated with a user during a test session from one or more local input sources, when the test session is hosted locally on the user device 200. The one or more user data comprises user behaviour data and user environment data. The user behaviour data may include the user's gaze to identify the direction of gaze to identify if the user is looking away from a display screen of the user device 200. The user behaviour data may include data containing information of the active application on the display screen of the user device 200. If the user tries to browse search engines, or any document online, or on the user device 200, or the user tries to communicate with others in order to cheat during the test session, the data of such activity of the user is acquired by the data acquisition module 110. The user behaviour data is also captured to keep track of application or window in focus on the user device 200 to identify if the user switches to a different application or window either intentionally or being prompted by any other external factors. The external factors may be an incoming call, or the like. The user environment data includes data captured to indicate the number of users looking at the screen corresponding to the user device 200, to identify presence of any audio cues or messages present in the user environment, and/or to identify any sudden changes to audio/visual environment.

Further, the data acquisition module 110 is configured to determine whether the test session has been started by the user on the local user device 200. The data acquisition module 110 activates one or more local input sources for capturing the one or more user data after the test session is determined to be started by the user. The one or more user data is captured in real time. The data acquisition module 110 acquires the one or more user data associated with the user during the test session from the activated one or more local input sources. The one or more local input sources may be a camera, a microphone or an application change determination module and the like. The other local input source may be the screen that the user is looking at. Typically, during a test, the user is expected to look at the test and nothing else. If someone would like to cheat, the easiest way to do so is by opening websites such as for example Google or some such website. In this case, when the user moves away from the test screen, it is detected what other screen or application the user is switching into. In some embodiment, this action by the user of switching screens may be an unintentional event. For example, if the user is taking the test on the phone, and they receive a phone call. In some other embodiment, other times, this action by the user of switching screens may be a deliberate act of the user, such as opening Wikipedia or a textbook. The data acquisition module 110 takes a screenshot of the current screen the user is switching into and stores the screenshot. Later, a machine learning algorithm is run on these images to build a model of when the user is trying to cheat, and when the user did this involuntarily. Hence, the screen that the user is looking at becomes the input.

Another local input source may be Light Detection and Ranging (LIDAR). Recently, even smartphones are being shipped with LIDAR features. The video input can only get a sense of the user within the camera's field of view. Even if at the beginning of the test, the data acquisition module 110 surveyed the test environment around the user, during the test, objects (like a textbook or even another person) may move to a close proximity of the user. The LIDAR gives a more three-dimensional view of the objects around the test taking device, such as the user device 200. If the LIDAR senses that the test environment has changed significantly since the beginning of the test, that could be another indication that the user might be cheating. Hence, the LIDAR is another input source.

The data extraction module 115 is configured to extract one or more user assessment parameters from the acquired one or more user data locally on the user device 200. The one or more user assessment parameters comprise user facial parameters, user gesture parameters, user environment parameters, external audio parameter, external application parameter, event parameter, or any combination thereof.

The data assessment module 120 is configured to determine locally on the user device 200 whether the extracted one or more user assessment parameters violates the set of predefined test assessment criteria based on a machine learning based user assessment model. The machine learning based user assessment model represents a dynamic relationship between the extracted one or more user assessment parameters and the set of predefined test assessment criteria. The data assessment module 120 further comprises the machine learning based user assessment model generated for the user based on the extracted one or more user assessment parameters. The decision of whether the parameters violate the predefined criteria is processed locally on the user device, unlike conventional systems where this decision making is performed at the central server.

The data assessment module 120 is configured to classify the extracted one or more user assessment parameters based on the type of the acquired one or more user data. The type of the one or more user data comprises user behaviour data and user environment data. The data assessment module 120 dynamically correlates each of the classified one or more user assessment parameters with the set of predefined test assessment criteria. Further, the data assessment module 120 generates the machine learning based user assessment model for the user based on the dynamic correlation. The machine learning based user assessment model represents a dynamic relationship between the extracted one or more user assessment parameters and a set of predefined test assessment criteria.

The data assessment module 120 is further configured to determine locally on the user device 200 whether the extracted one or more user assessment parameters matches with corresponding pre-stored user assessment parameters present in the set of predefined test assessment criteria by comparing the extracted one or more user assessment parameters with the corresponding pre-stored user assessment parameters. The data assessment module 120 determines a deviation in the extracted one or more user assessment parameters based on the comparison. The data assessment module 120 further, determines whether the deviation is non-acceptable and intentional by the user using the generated machine learning based user assessment model.

The score generator module 125 is configured to generate a trust score for the user based on whether the extracted one or more user assessment parameters is determined to violate the set of predefined test assessment criteria. The score generator module first determines the type of deviation if the deviation is determined to be non-acceptable and intentional by the user. Thereafter, the score generator module 125 determines frequency and duration of the deviations based on the acquired one or more user data. Further, the score generator module 125 generates the trust score for the user based on the determined type of the deviation, determined frequency and the duration of the deviation. In an embodiment, there are two steps to calculate the trust score. First, a set of algorithms is required to detect different kinds of violations, based on the different local input sources (for example, opened Google, multiple faces were detected, and the like). Later, depending on the type, frequency and duration of these violations, the score generator module 125 calculates the trust score. This calculation is also Machine Learning driven. For the first set of algorithms, in some cases, off-the-shelf ML models, such as TensorFlow are used for face detection. For other kinds of violations, such as the audio detected, a dedicated algorithm is built that helps distinguish between the ambient noise and if someone is prompting the user for an answer. For example, the duration and loudness of these noises are taken into account in such cases. Eventually, the computing system 100 is capable of distinguishing human voice from other sounds. For the algorithm that involves calculating the trust score, the machine learning models may self-learn and generate a trust score, based on the history of other tests, and the like.

The notification generator module 130 is configured to generate a notification message indicating violation of test by the user based on the generated trust score. The display module 135 is configured to output the trust score and the generated notification message on a user interface of the user device.

In an exemplary embodiment, as the computing system 100 has a camera, the camera captures details about eye direction, gaze direction, head posture, face direction, and the like of the user. Similarly, other input sources such as a microphone captures ambient noise, human noise, and the like. These inputs are then run against a machine learning algorithm (like, for example, neural networks) to detect features such as how many faces are visible on the screen, is the user constantly looking away from the screen, is the user getting audio inputs from outside, and the like.

There are two parts to this process: (i) training and (ii) inference. The training is where the machine learning algorithms learn to detect these factors, and inference is where they use their learnings and provide a real-time predictions on events occurring currently associated with the user (for example, his behaviours, his environment, application change and the like). The training happens from two sources: (i) pre-compiled files that load when the computing system 100 loads and (ii) real-time files that are generated that are specific to the user's environment. In case of the pre-compiled files, before the computing system 100 goes into production, multiple different videos are obtained in many different environments where the user is not cheating on the test. The pre-compiled files are then generated using this method. In case of real time files, when the user starts with a web application hosted on the computing system (100), the specific user is intimated to perform some actions that train the ML algorithm. This generates the real-time files. These real-time files are optionally being sent to a central server (not shown) to update the pre-compiled files. Although the files are being sent to the server, the inference happens locally on the user device 200. The files are uploaded to the server, depending on bandwidth, and the like to improve the performance of the next inference.

Also, in any case only pre-compiled files, only real-time files or a combination of both may be considered for performing training and inference.

Those skilled in the art will appreciate that the hardware depicted in FIG. 1 may vary for particular implementations. For example, other peripheral devices such as an optical disk drive and the like, Local Area Network (LAN), Wide Area Network (WAN), Wireless (e.g., Wi-Fi) adapter, graphics adapter, disk controller, input/output (I/O) adapter also may be used in addition or in place of the hardware depicted. The depicted example is provided for the purpose of explanation only and is not meant to imply architectural limitations with respect to the present disclosure.

Those skilled in the art will recognize that, for simplicity and clarity, the full structure and operation of all data processing systems suitable for use with the present disclosure is not being depicted or described herein. Instead, only so much of a system 100 as is unique to the present disclosure or necessary for an understanding of the present disclosure is depicted and described. The remainder of the construction and operation of the system 100 may conform to any of the various current implementations and practices known in the art.

FIG. 2 is a block diagram illustrating an exemplary method for locally assessing a user during a test session, in accordance with an embodiment of the present disclosure. At step 310, a data acquisition module 110 acquires one or more user data associated with the user during the test session from one or more local input sources. The test session is hosted locally on the user device 200. The one or more user data comprises user behaviour data and user environment data.

The user behaviour data may include the user's gaze to identify the direction of gaze to identify if the user is looking away from a display screen of the user device 200. The user behaviour data may include data containing information of the active application on the display screen of the user device 200. If the user tries to browse search engines, or any document on the user device 200 for cheating during the test session, the data of such activity of the user is acquired by the data acquisition module 110. The user behaviour data is also captured to keep track of the application or window in focus on the user device 200 to identify if the user switches to a different application or window either intentionally or being prompted by any other external factors. The user environment data includes data captured to indicate the number of users on the screen corresponding to the user device 200, to identify presence of any audio cues or messages present in the user environment, and/or to identify any sudden changes to audio/visual environment.

In acquiring one or more user data associated with the user during the test session from one or more local input sources, the method comprises determining whether the test session has been started by the user on the local user device 200. Further, the one or more local input sources are activated for capturing the one or more user data after the test session is determined to be started by the user. The one or more user data is captured in real time. The one or more user data associated with the user during the test session is acquired from the activated one or more local input sources.

At step 320, a data extraction module 115 extracts one or more user assessment parameters from the acquired one or more user data locally on the user device 200. The one or more user assessment parameters comprise user facial parameters, user gesture parameters, user environment parameters, external audio parameter, external application parameter, event parameter, or any combination thereof.

At step 330, a data assessment module 120 determines, locally at the user device 200 whether the extracted one or more user assessment parameters violates the set of predefined test assessment criteria based on a machine learning based user assessment model. The machine learning based user assessment model represents a dynamic relationship between the extracted one or more user assessment parameters and a set of predefined test assessment criteria. In determining whether the extracted one or more user assessment parameters violates the set of predefined test assessment criteria, the method further includes generating the machine learning based user assessment model for the user based on the extracted one or more user assessment parameters. In generating the machine learning based user assessment model for the user based on the extracted one or more user assessment parameters, the method includes classifying the extracted one or more user assessment parameters based on the type of the acquired one or more user data. Further, each of the classified one or more user assessment parameters is dynamically correlated with the set of predefined test assessment criteria. The machine learning based user assessment model is generated for the user based on the dynamic correlation. The machine learning based user assessment model represents a dynamic relationship between the extracted one or more user assessment parameters and the set of predefined test assessment criteria.

In determining whether the extracted one or more user assessment parameters violates the set of predefined test assessment, the method includes determining locally at the user device 200, whether the extracted one or more user assessment parameters matches with corresponding pre-stored user assessment parameters present in the set of predefined test assessment criteria by comparing the extracted one or more user assessment parameters with the corresponding pre-stored user assessment parameters. A deviation in the extracted one or more user assessment parameters is determined based on the comparison. Further, it is determined whether the deviation is non-acceptable and intentional by the user using the generated machine learning based user assessment model. The set of predefined test assessment criteria comprises users' eye, head position, presence of external audio or video feeds, switching of screens by the user intentionally and the like.

At step 340, a score generator module generates a trust score for the user based on whether the extracted one or more user assessment parameters is determined to violate the set of predefined test assessment criteria. In generating the trust score, the method includes determining the type of the deviation if the deviation is determined to be non-acceptable and intentional by the user. Thereafter, the method includes determining frequency and duration of the deviation based on the acquired one or more user data. Further, the method includes generating the trust score for the user based on the determined type of the deviation, determined frequency and the duration of the deviation.

At step 350, the notification generator module generates a notification message indicating violation of test conditions by the user based on the generated trust score. At step 360, a display module outputs the trust score and the generated notification message on a user interface of the user device 200.

One of the most important features of the system and the method for locally assessing the user during a test session, described in the present invention is acquiring and analysing the user data locally on the user device 200 itself instead of sending the captured data to a remote server for processing. The system and method for locally assessing a user during a test session is agnostic to high bandwidth network connection, or high computing requirements. Therefore, the system disclosed in the present invention saves tremendous computing power as well as network bandwidth.

The technical effect of the present invention lies in the fact that an ordinary computing device or smart device is upgraded and enabled to perform computation heavy process of analysing the external audio and video feeds, device operation parameters to assess the user facial parameters, user gesture parameters, user environment parameters, external audio parameter, external application parameter, event parameter, or any combination thereof in real time without sending the aforementioned data to a robust back end server. The present invention also brings down the heavy dependence on High broadband speed for carrying out proctoring, since the user device is not required to transmit external audio and video feeds, device operation parameters to a back-end server for processing and analysis.

The system and the method described in the present invention can be implemented for assessment of plurality of individuals where computers or invigilators may not be available for conducting physical online computerised tests or monitoring of a large number of users virtually. Further the system allows the user to take online computerised tests from the comfort of their home without any monitoring by another individual, either physically or virtually. As the analysis is happening locally (that is, not on a server), significantly fewer computing resources are required. Further, as the data does not require to be communicated to a server, the bandwidth requirement from a network perspective is almost nil. Further, because network connectivity is not required, the tests can be administered in poor networking or no networking conditions. The results can then be synced with the server later.

Also, as only violations of the test conditions are captured and stored, this method is much less intrusive than conventional proctoring systems where the entire test session is stored. In particular, if the system detects no violations, no image or audio data of the user needs to be stored.

Conclusively, fully automating the assessing or proctoring process and decentralising the assessing or proctoring to the user devices, locally where the tests are hosted, results in an ultra-scalable, always-available means of ensuring that students are not cheating on online tests.

It will be understood by those skilled in the art that the foregoing general description and the following detailed description are exemplary and explanatory of the disclosure and are not intended to be restrictive thereof.

While specific language has been used to describe the disclosure, any limitations arising on account of the same are not intended. As would be apparent to a person skilled in the art, various working modifications may be made to the method in order to implement the inventive concept as taught herein.

The figures and the foregoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, the order of processes described herein may be changed and are not limited to the manner described herein. Moreover, the actions of any flow diagram need not be implemented in the order shown; nor do all of the acts need to be necessarily performed. Also, those acts that are not dependent on other acts may be performed in parallel with the other acts. The scope of embodiments is by no means limited by these specific examples.

1. A system for locally assessing a user during a test session on a user device, the system comprising:
one or more hardware processors on the user device; and
a memory on the user device coupled to the one or more hardware processors, wherein the memory comprises a plurality of modules in the form of programmable instructions executable by the one or more hardware processors, wherein the plurality of modules comprises:
a data acquisition module configured to acquire one or more user data associated with a user during a test session from one or more local input sources, wherein the test session is hosted locally on the user device;
a data extraction module configured to extract one or more user assessment parameters from the acquired one or more user data locally on the user device;
a data assessment module configured to determine, locally on the user device, whether the extracted one or more user assessment parameters violates the set of predefined test assessment criteria based on a machine learning based user assessment model, wherein the user assessment model represents a dynamic relationship between the extracted one or more user assessment parameters and a set of predefined test assessment criteria;
a score generator module configured to generate a trust score for the user based on whether the extracted one or more user assessment parameters is determined to violate the set of predefined test assessment criteria; and
a notification generator module configured to generate a notification message indicating violation of test by the user based on the generated trust score; and
a display module configured to output the trust score and the generated notification message on a user interface of the user device.

2. The system as claimed in claim 1, wherein the one or more user data comprises user behaviour data and user environment data.

3. The system as claimed in claim 1, wherein in acquiring the one or more user data associated with the user during the test session from the one or more local input sources comprises, the data acquisition module is configured to:
determine whether the test session has been started by the user on the local user device;
activate one or more local input sources for capturing the one or more user data after the test session is determined to be started by the user, wherein the one or more user data is captured in real time; and
acquire the one or more user data associated with the user during the test session from the activated one or more local input sources.

4. The system as claimed in claim 1, wherein the one or more user assessment parameters comprise user facial parameters, user gesture parameters, user environment parameters, external audio parameter, external application parameter, event parameter, or any combination thereof.

5. The system as claimed in claim 1, the data assessment module further comprises the machine learning based user assessment model generated for the user based on the extracted one or more user assessment parameters.

6. The system as claimed in claim 1, wherein in determining whether the extracted one or more user assessment parameters violates the set of predefined test assessment criteria based on the machine learning based user assessment model, the data assessment module is configured to:
classify the extracted one or more user assessment parameters based on type of the acquired one or more user data;
dynamically correlate each of the classified one or more user assessment parameters with the set of predefined test assessment criteria; and
generate the machine learning based user assessment model for the user based on the dynamic correlation, wherein the machine learning based user assessment model represents dynamic relationship between the extracted one or more user assessment parameters and a set of predefined test assessment criteria.

7. The system as claimed in claim 1, wherein in determining whether the extracted one or more user assessment parameters violates the set of predefined test assessment criteria based on the machine learning based user assessment model, the data assessment module is configured to:
determine whether the extracted one or more user assessment parameters matches with corresponding pre-stored user assessment parameters present in the set of predefined test assessment criteria by comparing the extracted one or more user assessment parameters with the corresponding pre-stored user assessment parameters;
determine a deviation in the extracted one or more user assessment parameters based on the comparison; and
determine whether the deviation is non-acceptable and intentional by the user using the generated machine learning based user assessment model.

8. The system as claimed in claim 1, wherein in generating the trust score for the user based on whether the extracted one or more user assessment parameters is determined to violate the set of predefined test assessment criteria, the score generator module is configured to:
determine type of the deviation if the deviation is determined to be non-acceptable and intentional by the user;
determine frequency and duration of the deviation based on the acquired one or more user data; and
generate the trust score for the user based on the determined type of the deviation, determined frequency and the duration of the deviation.

9. A method for locally assessing a user during a test session on a user device, the method comprising:
Acquiring, by a data acquisition module executable by one or more hardware processors on a user device, one or more user data associated with a user during a test session from one or more local input sources, wherein the test session is hosted locally on a user device;
extracting, by a data extraction module executable by the one or more hardware processors on the user device, one or more user assessment parameters from the acquired one or more user data locally on the user device;
determining, by a data assessment module executable by the one or more hardware processors on the user device, whether the extracted one or more user assessment parameters violates the set of predefined test assessment criteria based on a machine learning based user assessment model,
wherein the user assessment model represents dynamic relationship between the extracted one or more user assessment parameters and a set of predefined test assessment criteria;
generating, by a score generator module executable by the one or more hardware processors on the user device, a trust score for the user based on whether the extracted one or more user assessment parameters is determined to violate the set of predefined test assessment criteria; and
generating, by a notification generator module executable by the one or more hardware processors on the user device, a notification message indicating violation of test by the user based on the generated trust score; and
outputting, by a display module executable by the one or more hardware processors on the user device, the trust score and the generated notification message on a user interface of the user device.

10. The method as claimed in claim 9, wherein the one or more user data comprises user behaviour data and user environment data.

11. The method as claimed in claim 9, wherein in acquiring the one or more user data associated with the user during the test session from the one or more local input sources comprises:
determining whether the test session has been started by the user on the local user device;
activating one or more local input sources for capturing the one or more user data after the test session is determined to be started by the user, wherein the one or more user data is captured in real time; and
acquiring the one or more user data associated with the user during the test session from the activated one or more local input sources.

12. The method as claimed in claim 9, wherein the one or more user assessment parameters comprise user facial parameters, user gesture parameters, user environment parameters, external audio parameter, external application parameter, event parameter, or any combination thereof.

13. The method as claimed in claim 9, further comprising generating the machine learning based user assessment model for the user based on the extracted one or more user assessment parameters.

14. The method as claimed in claim 13, wherein in generating the machine learning based user assessment model for the user based on the extracted one or more user assessment parameters comprises:
classifying the extracted one or more user assessment parameters based on type of the acquired one or more user data;
dynamically correlating each of the classified one or more user assessment parameters with the set of predefined test assessment criteria; and
generating the machine learning based user assessment model for the user based on the dynamic correlation, wherein the machine learning based user assessment model represents dynamic relationship between the extracted one or more user assessment parameters and a set of predefined test assessment criteria.

15. The method as claimed in claim 9, wherein determining whether the extracted one or more user assessment parameters violates the set of predefined test assessment criteria based on the generated machine learning based user assessment model comprises:
determining whether the extracted one or more user assessment parameters matches with corresponding pre-stored user assessment parameters present in the set of predefined test assessment criteria by comparing the extracted one or more user assessment parameters with the corresponding pre-stored user assessment parameters;
determining a deviation in the extracted one or more user assessment parameters based on the comparison; and
determining whether the deviation is non-acceptable and intentional by the user using the generated machine learning based user assessment model.

16. The method as claimed in claim 9, wherein generating the trust score for the user based on whether the extracted one or more user assessment parameters is determined to violate the set of predefined test assessment criteria comprises:
determining type of the deviation if the deviation is determined to be non-acceptable and intentional by the user;
determining frequency and duration of the deviation based on the acquired one or more user data; and
generating the trust score for the user based on the determined type of the deviation, determined frequency and the duration of the deviation.
